(19) United States
(12) Patent Application Publication
(10) Pub. No.: US 2009/0225147 A1
(43) Pub. Date: Sep. 10, 2009

(54) Exposing Device, Image Forming Apparatus and Reading Apparatus

(75) Inventor: Akihiro YAMAMURA, Minato-Ku (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/391,647

(22) Filed: Feb. 24, 2009

(30) Foreign Application Priority Data
Mar. 6, 2008 (JP) 2008-057011

(51) Int. Cl. B41J 2/385

(52) U.S. Cl. 347/130

(57) ABSTRACT

An exposing device is supplied capable of producing a high-resolution printing image, and being easily manufactured as the position adjustment of the lens is not necessary. In the exposing device, a radiation point array substrate that arranges plural radiation point arrays with plural radiation points in a straight line, in plural straight lines with predetermined interval; and a lens array substrate that is set up to correspond to the respective radiation point arrays and has plural lenses forming enlargement image of the radiation point array, wherein the radiation point array substrate almost parallels the lens array substrate under the condition that optical axis of each radiation point array is adjusted to that of each lens, and when a distance of the radiation points on both ends of the radiation point array is served as “SY” and an absolute value of magnification of the lens is served as “mag”, formula “SY≦12.0/mag” holds.

### FIELD OF THE INVENTION

The invention relates to an exposing device in an image forming apparatus and a reading apparatus.

### BACKGROUND OF THE INVENTION

Until now, as an LED writing device (exposing device) used in an electrophotographic printer, an LED head is known to enlarge and project the light of an LED array that sets up plural LEDs in one line.

In the related LED head, as the field of LEDs arranged on the LED array is smaller than the printing field of a printer, through enlarging the image of the LED array and forming it on photosensitive body drum, it is possible to form an image as large as the printing field. Further, the LEDs on the LED array are arranged in a higher density than the printing image of the printer. It may refer to Patent Document 1.

As shown in FIG. 2 of Patent Document 1, the LED writing device in the patent document 1 includes a loading substrate that loads the LED array, a circular convex lens that enlarges and projects the light of the LED array and a frame fixes the loading substrate and the LED array, within the fringe of the circular convex lens is fixed tightly by the stopper and the lens fixing ring in the maintaining section of the frame.

Patent Document 1: Japan patent publication of No. Heisei 07-314771.

However, in the LED writing device in Patent Document 1, as only one circular convex lens enlarges and projects the light of all LEDs in a line, it is difficult to get full-resolution image. Therefore, it is impossible to get high-resolution printing image.

Further, in order to get full-resolution image, the optics system becomes more complex and cost gets higher while the device also becomes larger.

Moreover, as the circular convex lens is fixed by the stopper and the lens fixing ring, the position adjustment (optical axis adjustment) of the LED array and the circular convex lens is complex when the device is assembled and the productivity is low.

### SUMMARY OF THE INVENTION

It is, therefore, an objective of the invention to provide an exposing device, an image forming apparatus including the exposing device and a reading apparatus that can solve the above problem, so as to produce a high-resolution printing image, and can be easily manufactured as the position adjustment of the lens is not necessary.

A first aspect of the invention is to provide an exposing device which comprises a radiation point array substrate that arranges plural radiation point arrays with plural radiation points in a straight line, in plural straight lines with predetermined interval; and a lens array substrate that is set up to correspond to the respective radiation point arrays and has plural lenses forming enlargement image of the radiation point array, wherein the radiation point array substrate almost parallels the lens array substrate under the condition that optical axis of each radiation point array is adjusted to that of each lens, and when a distance of the radiation points on both ends of the radiation point array is served as “SY” and an absolute value of magnification of the lens is served as “mag”, formula “SY≦12.0/mag” holds.

A second aspect of the invention is to provide an image forming apparatus which comprises an exposing device, the exposing device includes a radiation point array substrate that arranges plural radiation point arrays with plural radiation points in a straight line, in plural straight lines with predetermined interval; and a lens array substrate that is set up to correspond to the respective radiation point arrays and has plural lenses forming enlargement image of the radiation point array, wherein the radiation point array substrate almost parallels the lens array substrate under the condition that optical axis of each radiation point array is adjusted to that of each lens, and when a distance of the radiation points on both ends of the radiation point array is served as “SY” and an absolute value of magnification of the lens is served as “mag”, formula “SY≦12.0/mag” holds.

A third aspect of the invention is to provide an reading apparatus which comprises an image shooting section that arranges plural light receiving element arrays with plural light receiving elements in a straight line, in plural straight lines with predetermined interval; and a lens array substrate that is set up to correspond to each light receiving element array and has plural lens to form reduction image of manuscript image on the light receiving element array, wherein the image shooting section almost parallels the lens array substrate under the condition that optical axis of each light receiving element array is adjusted to that of each lens, and when the distance of the light receiving elements on both ends of the light receiving element array is served as “RY” and the absolute value of reduction rate of the lens is served as “red”, formula “RY≦12.0×red” holds.

### EFFECT OF THE INVENTION

According to the exposing device, the image forming apparatus and the reading apparatus of the invention, as each lens on the lens array substrate forms an enlargement image of each radiation point array on the radiation point array substrate, it is possible to get full-resolution image with simply structure and reduced numbers of parts.

Further, as the optical axis of each radiation point array and each lens are formed as a unified entity, it is possible to provide easy position adjustment for the lens and have high productivity while reducing the size of the device.

Further, through using the exposing device stated above, it is not necessary to adjust the position of the lens, therefore, possible to get a high precision image forming apparatus that can produce high-resolution printing image.

Further, according to the invention, as each lens on the lens array substrate forms a reduction image of manuscript image on each light receiving element array in the image shooting section, it is possible to get full-resolution image with simply structure and reduced numbers of parts.

Further, as the optical axis of each light receiving element array and each lens are formed as a unified entity, it is not necessary to adjust the position of the lens, therefore, possible to have high productivity while reducing the size of the device.

The above and other objects and features of the present invention will become apparent from the following detailed description and the appended claims with reference to the accompanying drawings.

### BRIEF DESCRIPTION OF THE DRAWINGS

FIG. 1 is a diagram showing a main structure of an image forming apparatus in embodiment 1;

FIG. 2 is an exploded oblique diagram showing an LED head;

FIG. 3 is a cross-sectional side view showing an LED head;

FIG. 4 is a diagram showing a structure of an LED head;

FIG. 5 is a diagram showing the magnification of a micro lens;

FIG. 6 is a diagram showing a position of an image on the photosensitive body formed by a radiation light of LED element;

FIG. 7 is a block diagram showing a structure of an LED controlling section;

FIG. 8 is a diagram showing that useless radiation light of LED element is shaded in the image forming process;

FIG. 9 is a diagram showing that an image is formed by a radiation light of LED element on the photosensitive body drum;

FIG. 10 is a diagram showing an evaluation of image;

FIG. 11 is a diagram showing an LED head in embodiment 1 and a LED head in comparison example;

FIG. 12 is a diagram showing a “mag-SY” curve;

FIG. 13 is a diagram showing a main structure of a reading apparatus in embodiment 2;

FIG. 14 is a diagram showing a structure of a reading head;

FIG. 15 is a cross-sectional side view showing a reading head;

FIG. 16 is a diagram showing a structure of a light receiving element array;

FIG. 17 is a diagram showing a position on a light receiving element array formed by an incident light of manuscript image;

FIG. 18 is a diagram showing the reduction rate of a micro lens;

FIG. 19 is a block diagram showing a structure of a reading controlling section;

FIG. 20 is a diagram showing a reading head in embodiment 2 and a reading head in comparison example; and

FIG. 21 is a diagram showing a “red-RY” curve.

### DETAILED DESCRIPTION OF THE PREFERRED EMBODIMENTS

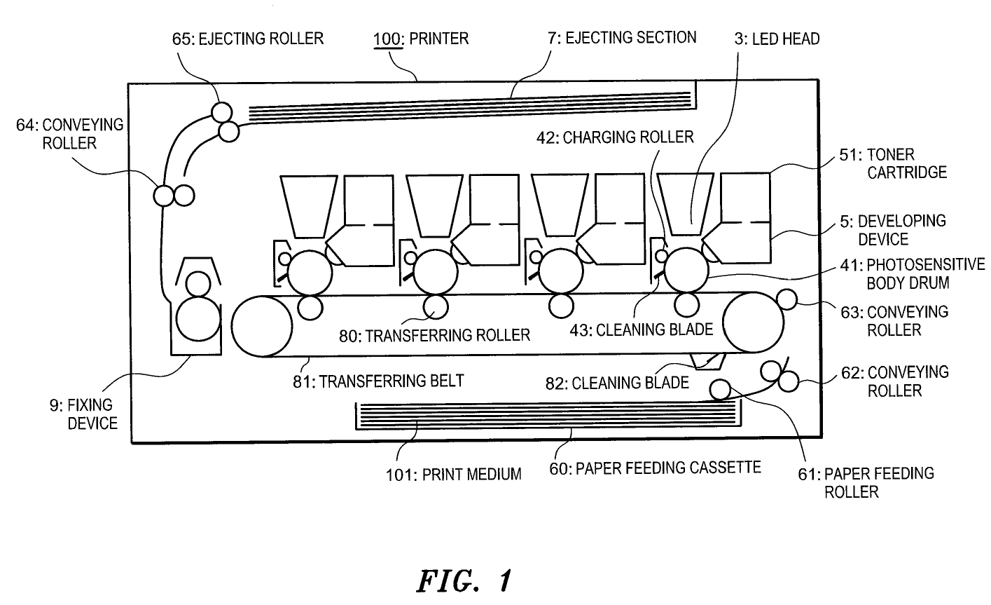

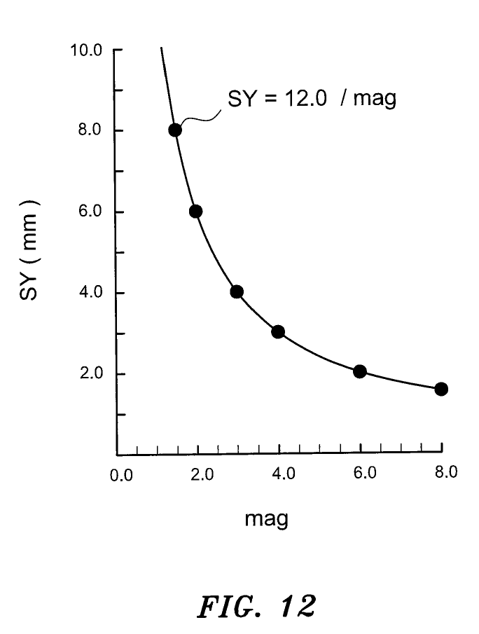

Embodiments of the invention will be described in detail hereinbelow with reference to the drawings. Here, it is to explain an image forming apparatus in embodiment 1 of the present invention on the basis of FIG. 1˜FIG. 12.

### Embodiment 1

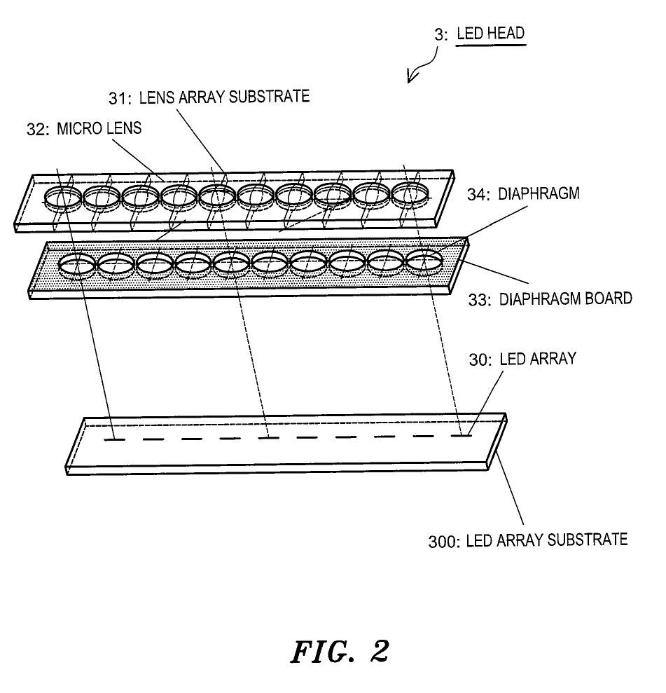

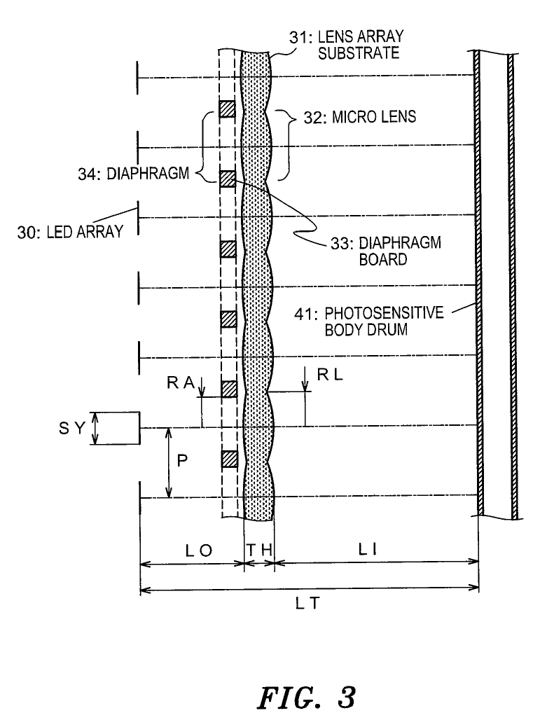

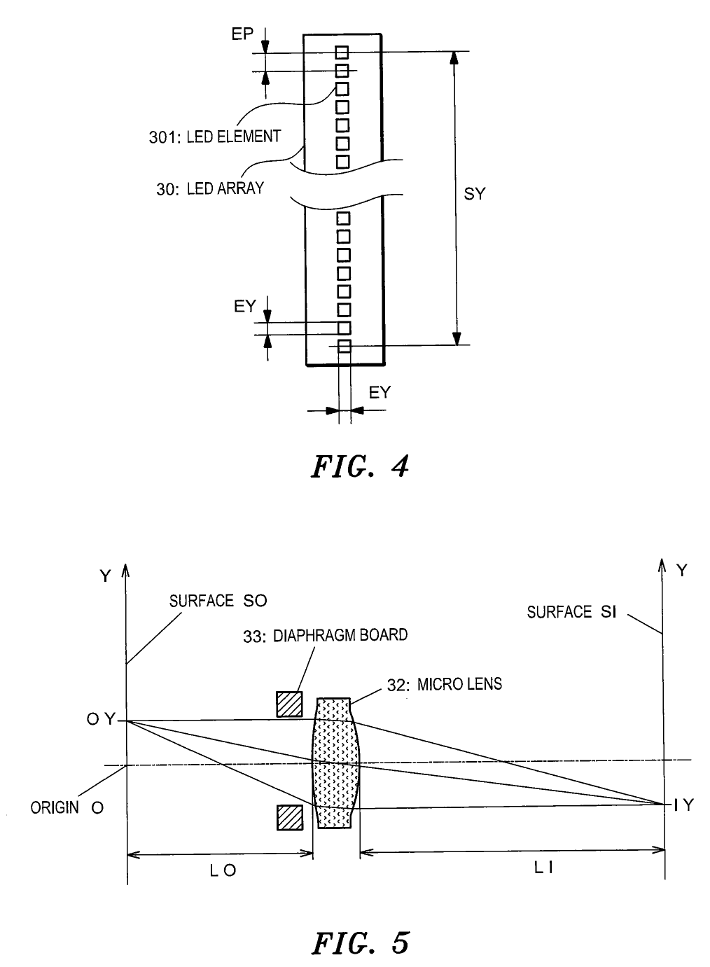

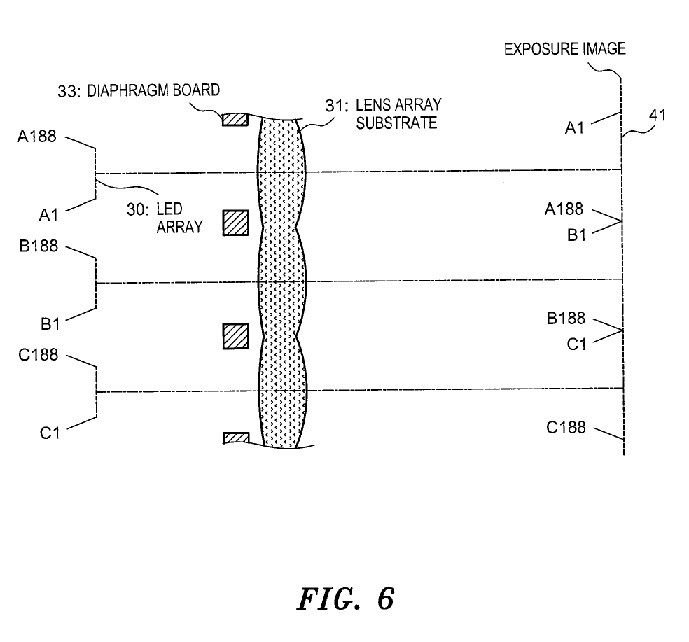

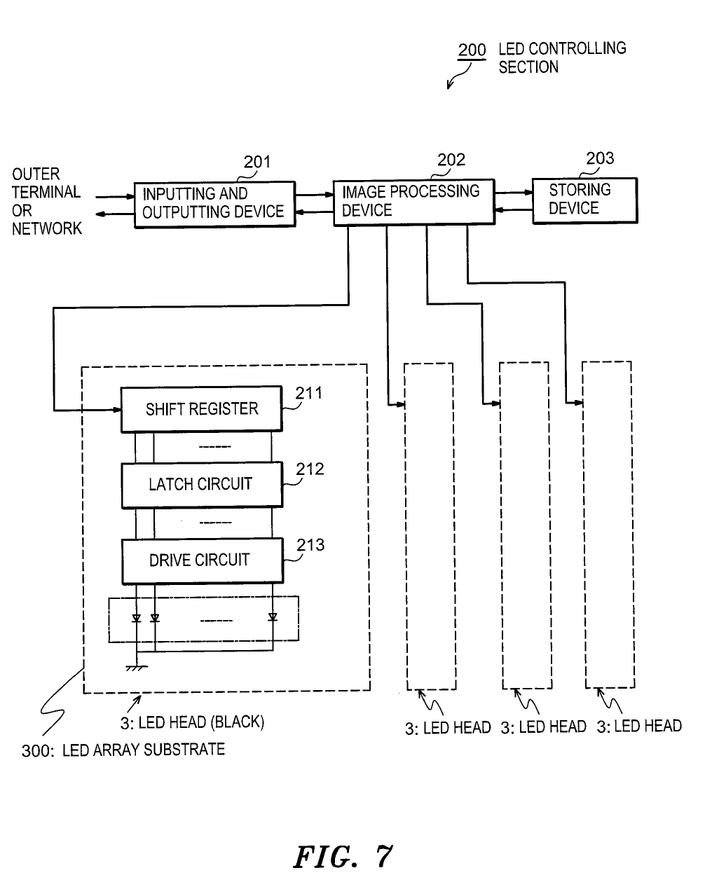

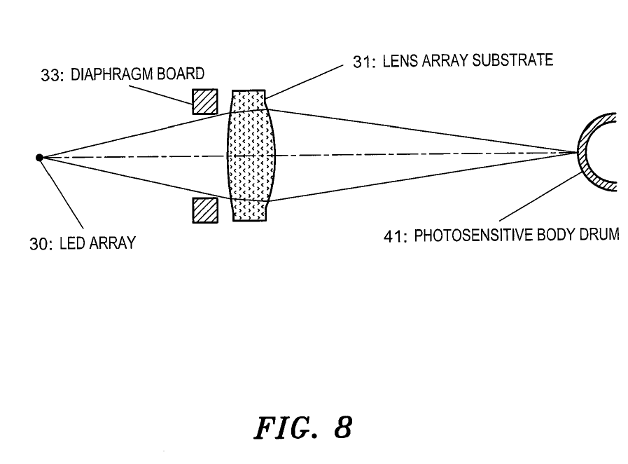

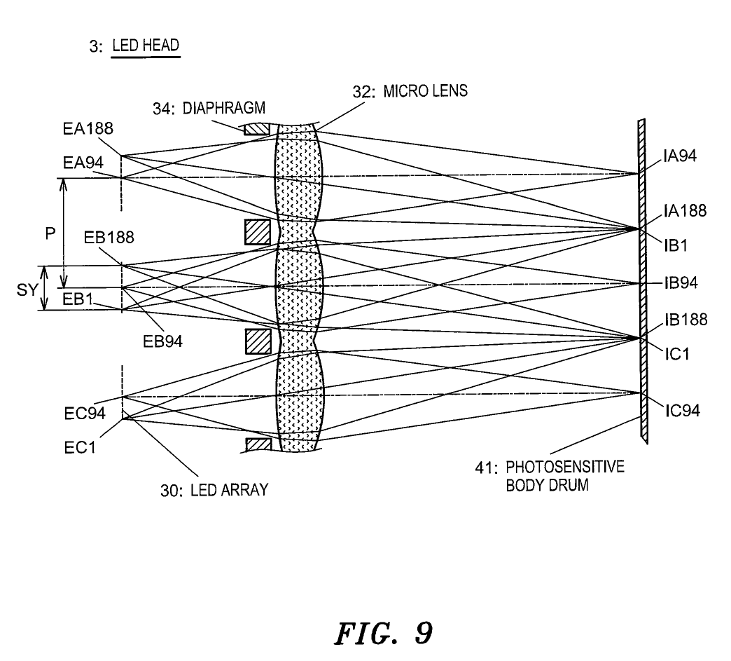

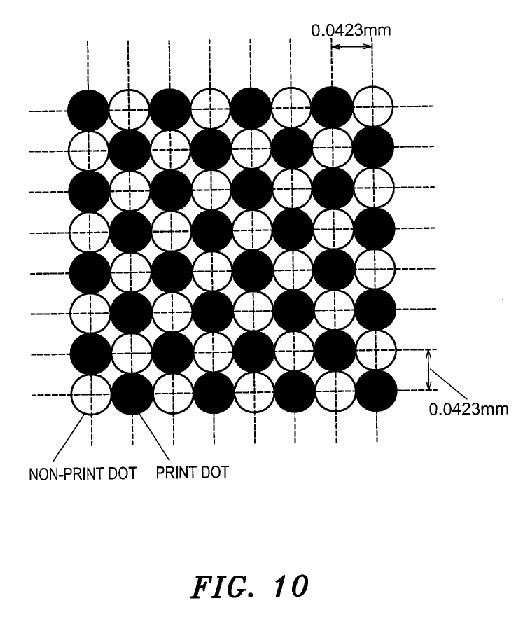

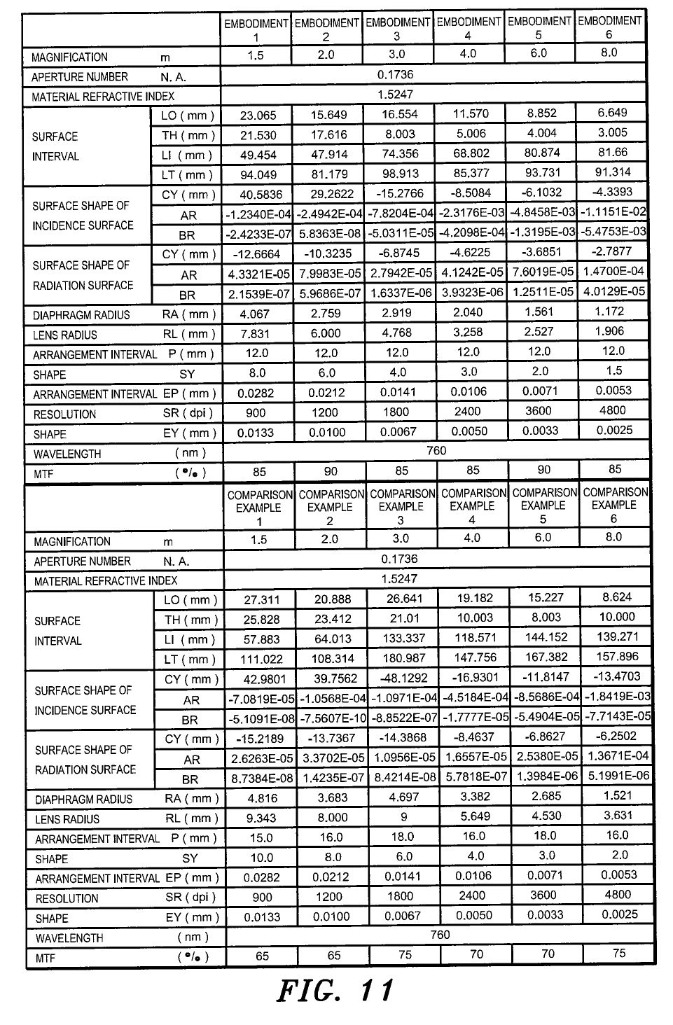

FIG. 1 is a diagram showing a main structure of an image forming apparatus in embodiment 1; FIG. 2 is an exploded oblique diagram showing an LED head; FIG. 3 is a cross-sectional side view showing an LED head; FIG. 4 is a diagram showing a structure of an LED head; FIG. 5 is a diagram showing the magnification of a micro lens; FIG. 6 is a diagram showing a position of a image on the photosensitive body formed by a radiation light of LED element; FIG. 7 is a block diagram showing a structure of an LED controlling section; FIG. 8 is a diagram showing that a useless radiation light of LED element is shaded in the image forming process; FIG. 9 is a diagram showing that an image is formed by a radiation light of LED element on the photosensitive body drum; FIG. 10 is a diagram showing an evaluation of image; FIG. 11 is a diagram showing an LED head in embodiment 1 and a LED head in comparison example; and FIG. 12 is a diagram showing a “mag-SY” curve;

Image forming apparatus 100 in embodiment 1 is a color electrophotographic printer 100, wherein a toner containing pigment with resin as color material forms an image on a print medium on the basis of the image data inputted from outside.

Printer 100, as shown in FIG. 1, includes paper feeding cassette 60, print medium 101 that accommodates paper feeding cassette 60, paper feeding roller 61 that takes out print medium 101 from paper feeding cassette 60, conveying roller 62 and 63 that convey print medium 101, photosensitive body drum 41 as an electrostatic latent image carrying body that forms image of colors of yellow, magenta, cyan and black, developing device 5 that develops a toner image of the electrostatic latent image formed by photosensitive body drum 41 by using a toner, toner cartridge 51 that supplies the toner in developing device 5, charging roller 42 that supplies electric charge to the surface of photosensitive body drum 41 by using fixed voltage, LED head 3 (exposing device) that radiates light selectively on the basis of the image data formed on the surface of charged photosensitive body drum 41 and forms an electrostatic latent image, cleaning blade 43 on contact to photosensitive body drum 41 that scratches the toner remained on the surface of photosensitive body drum 41.

Moreover, an image forming section includes photosensitive body drum 41 of different colors stated above, developing device 5, toner cartridge 51, charging roller 42, LED head 3 and cleaning blade 43.

Further, printer 100 also has transferring roller 80 of different colors of yellow, magenta, cyan and black, transferring belt 81, cleaning blade 43, fixing device 9, conveying roller 64, ejecting roller 65 and ejecting section 7.

Transferring roller 80 is set up opposite to photosensitive body drum 41 to fix transferring belt 81 in the transferring section. It transfers the toner image formed on photosensitive body drum 41 onto print medium 101 by using fixed voltage. Transferring belt 81 then conveys print medium 101 transferred with the toner image. Cleaning blade 43 cleans the surface of transferring belt 81.

Fixing device 9 fixes the toner image formed on print medium 101 by using heat and pressure while conveying the print medium 101 fixed with the toner image to conveying roller 64. Conveying roller 64 then conveys print medium 101 to ejecting roller 65. Ejecting roller 65 ejects print medium 101 to ejecting section 7. Ejecting section 7 accommodates print medium 101 that was printed.

Further, rollers such as transferring belt 81, photosensitive body drum 41, paper feeding roller 61, conveying roller 62 and 63, charging roller 42 and ejecting roller 65 are rotated and driven by a motor (not shown) and a gear (not shown). Developing device 5, LED head 3, fixing device 9, motors (not shown) and their electric supplies (not shown) are connected with the drive controlling device.

LED head 3 stated above, as shown in FIG. 2 and FIG. 4, includes LED array substrate 300 arranging LED array 30 with plural LED element 301 in a straight line in plural straight lines with predetermined interval; diaphragm board 33 with diaphragm 34 forms an aperture section stopping down the useless radiation lights of LED array 30 during the image forming process; lens array substrate 31 with plural micro lens 32 enlarges the image formed by the light of each LED array 30.

On LED array substrate 300, diaphragm board 33 and lens array substrate 31, LED array 30, diaphragm 34 and micro lens 32 are set up opposite to each other and formed as a unified entity.

LED array 30 stated above, as shown in FIG. 3, is set up in a line with predetermined interval “P” in the same arrangement direction as LED element 301. Micro lens 32 and diaphragm 34 are set up in straight lines with predetermined interval as LED array 30 and parallel the arrangement direction of LED array 30. The center of the arrangement direction of LED element on LED array 30, diaphragm 34 and micro lens 32 are set up under the conditions that the optical axis of them are in unison.

Here, the interval between LED array 30 and micro lens 32 is served as “LO”; the interval between the incidence surface and the radiation surface of micro lens 32 is served as “TH”. The interval of micro lens 32 and photosensitive body drum 41 served as is “LI”; the interval of LED array 30 and photosensitive body drum 41 is served as “LT”. The radius of micro lens 32 is served as “RL”; the absolute value of the magnification is served as “mag”. The aperture radius of diaphragm 34 is served as “RA”.

LED array 30, as shown in FIG. 4, is formed by arranging plural LED element 301 serving as the radiation point in a straight line with predetermined interval “EP”. LED elements 301 forms a square with side length “EY”. Further, in the field of LED element 301 arranged on LED array 30, the length of the arrangement direction of LED element 301 is “SY”. That is, the distance between LED element 301 on both ends of LED array 30 is “SY”.

Moreover, the resolution of LED array 30 “SR” is shown by the number of LED element 301 arranged in every 1 inch (25.4 mm). Its unit is “dpi” (dot per inch).

Each micro lens 32 on lens array substrate 31 stated above is composed of one piece of lens.

Each surface of micro lens 32 in embodiment 1 is non-spherical shape, which can be shown by arithmetic formula 1 as follows.

### <Arithmetic Formula 1>

$$Z ( r ) = \frac{\frac{r}{CY}}{1 + \sqrt{1 - \frac{{r}^{2}}{{CY}^{2}}}} + {ARr}^{4} + {BRr}^{6} … \qquad ( Arithmetic formula 1 )$$

In arithmetic formula 1, “r”(mm) is the coordinate of the radius direction serving as the center of the optical axis of the lens surface; “CY” (mm) is curvature radius; AR and BR are non-spherical surface coefficient.

Lens array substrate 31 with plural micro lens 32 that were formed as a unified entity uses optics resin such as cycloolefin resin (ZEONEX (zeonex) E48R, manufactured by Japanese Zeon Cooperation) to form a shooting formation shape.

Here, it is to explain the magnification of micro lens 32 stated above on the basis of FIG. 5.

As shown in FIG. 5, a surface that was separated from “LO” by the incidence surface of micro lens 32 in the direction of the optical axis of micro lens 32 is served as surface “SO”; a surface that was separated from “LI” by the radiation surface of micro lens 32 in the direction of the optical axis of micro lens 32 is served as surface “SI”. Further, the crosspoint of surface “SO” and the optical axis of micro lens 32 is served as origin “O”; and the position of the light source is served as “OY”. When micro lens 32 forms an inverted image and the position of the formation image formed on surface “SI” by the light source is served as “IY”, the magnification of micro lens 32 becomes “−IY/OY”. Therefore, the absolute value of the magnification of micro lens 32 “mag” becomes “IY/OY”.

In embodiment 1, when the absolute value of the magnification of micro lens 32 is served as “mag”; the arrangement interval of LED element 301 is served as “EP”; the length of the arrangement direction of the LED array 30 is served as “SY”; and the arrangement interval of the LED array 30 is served as “P”, a LED head that satisfies the formula “P=mag×(SY+EP)” is formed.

Next, it is to explain the relation of the position of the formation image formed by the radiation light of each LED element 301 on LED array 30 on the basis of FIG. 6.

FIG. 6 is an example showing the arrangement of 188 LED element 301 on LED array 30. At this time, the resolution of LED array 30 “SR” is 1200 dpi and the length of the arrangement direction of LED element 301 “SY” is 4.0 mm.

In FIG. 6, there are 188 dot images formed on photosensitive body drum 41 by the radiation light of LED element 301 in each line. The three lines are set as “A”, “B” and “C”, and the dots are set as “A-1”, “A-2”, . . . “A-187”, “A-188”, “B-1”, “B-2”, . . . “B-187”, “B-188”, “C-1”, “C-2”, . . . “C-187”, “C-188” from the top to the bottom. At this time, as each micro lens 32 forms an inverted enlargement image, LED element 301 corresponding to each dot image is set as “A-1”, “A-2”, . . . “A-187”, “A-188”, “B-1”, “B-2”, . . . “B-187”, “B-188”, “C-1”, “C-2”, . . . “C-187”, “C-188” from the top to the bottom.

Hence, in LED head 3 in embodiment 1, as the dot image is enlarged and formed by LED element 301 on each LED array 30 with predetermined interval, images are formed in a continuous line on photosensitive body drum 41.

Further, printer 100 includes an outer device that receives the image data and LED controlling section 200 that controls LED head 3 on the basis of the receiving data.

LED controlling section 200 stated above, as shown in FIG. 7, includes inputting and outputting device 201 that receives the image data from the outer device such as the outer terminal and network, storing device 203 that temporarily stores the receiving image data, image processing device 202 that reads the image data in storing device 203 and changes it into a page data of colors of cyan, magenta, yellow, black that can be printed on print medium 101. Further, in LED array substrate 300, shift register 211, latch circuit 212 and drive circuit 213 are installed to output one-line page data from image processing device 202 stated above to LED head 3 according to each color.

Next, it is to explain the action of printer 100 in embodiment 1 on the basis of FIG. 1.

The surface of photosensitive body drum 41 is charged by charging roller 42 that was driven by a power supply device (not shown). After photosensitive body drum 41 rotates, the charged surface of photosensitive body drum 41 gets around LED head 3; the surface of photosensitive body drum 41 is exposed by LED head 3; and the electrostatic latent image is formed on the surface of photosensitive body drum 41.

The electrostatic latent image on photosensitive body drum 41 is developed by developing device 5; and the toner image is formed.

On the other hand, print medium 101 set up in paper feeding cassette 60 was taken out from paper feeding cassette 60 by paper feeding roller 61, then is conveyed around transferring roller 80 and transferring belt 81 by conveying roller 62 and 63.

Further, after print medium 101 gets around transferring roller 80 and transferring belt 81, the toner image on photosensitive body drum 41 is transferred by transferring roller 80 and transferring belt 81 that were charged by a power supply device (not shown). Then, print medium 101 transferred with the toner image is conveyed to fixing device 9 by transferring belt 81.

The toner image on print medium 101 is melted by the pressure and heat of fixing device 9 and fixed on print medium 101. Furthermore, the fixed print medium 101 is ejected to ejecting section 7 by conveying roller 64 and ejecting roller 65.

Next, it is to explain the action of LED head 3 stated above on the basis of FIG. 7 and FIG. 8. In LED controlling section 200, the image data was inputted by an outer device (outer terminal, network) through inputting and outputting device 201 and temporarily stored in storing device 203. Then it is changed into the page data serving as the controlling data of LED head 3 in image processing device 202. The image data of black is changed into the page data of black; while the color images data is changed into the page data of colors of cyan, magenta, yellow, black. The page data of each color changed by image processing device 202 is sent to LED head 3 of different colors. The page data (for example, black) from image processing device 202 is conveyed and stored into shift register 211 orderly one line by one line as serial image data. And every one-line image data is stored in latch circuit 212 orderly. Then, drive circuit 213 drives (radiates) the LED element selectively on the basis of the storing data in latch circuit 212. Similarly, the page data of colors of yellow, magenta and cyan is sent to different LED head 3 and drives LED element 301 on LED array 30.

The radiation light controlled by drive circuit 213 is inverted, enlarged and projected onto the surface of photosensitive body drum 41 by the micro lens 32. And dots form images with predetermined interval “IP” in parallel with the arrangement direction of LED element 301. Moreover, in the radiation light of LED element 301, the useless light (stray light), as shown in FIG. 8, is shaded by diaphragm 34 on diaphragm board 33 during the image forming process.

The arrangement interval of the dot “IP” is shown by formula “IP=mag×EP”. Here, “EP” refers to the arrangement interval of LED element 301 and “mag” refers to the absolute value of magnification of micro lens 32.

Further, the resolution of LED head 3 “IR” is shown by the number of the dot formed on the photosensitive body drum 41 in 1 inch. The resolution of LED head 3 “IR” is shown by formula “IR=SR/mag”. Here, “SR” refers to the resolution (dpi) of LED array 30 “SR” and “mag” refers to the absolute value of magnification of micro lens 32.

Here, it is to explain the image forming process in which the radiation light from each LED array 30 in LED head 3 forms image on photosensitive body drum 41 on the basis of FIG. 9.

Moreover, it is to explain an example in which 188 LED elements 301 are arranged on each LED array 30; the absolute value of magnification of each micro lens 32 “mag” is doubled; and the arrangement pitch of micro lens 32 “P” is 8 mm.

At this time, the resolution of LED array 30 “SR” is 1200 dpi, the length of the arrangement direction of LED element 301 “SY” is 4.0 mm. Further, the resolution of the dot formed on photosensitive body drum 41 “IR” is 600 dpi; and the arrangement pitch of the dot “IP” is 0.0424 mm.

As shown in FIG. 9, after LED element 301 “EA94” on the optical axis of micro lens 32 on the upper part of the figure radiates, a dot with formation image “IA94” is formed on the optical axis of the micro lens 32 on the upper part of the figure. After LED element 301 “EA188” radiates, a dot with formation image “IA188” is formed 0.0424 mm above dot “IBI” that contains image formed by LED element 301 “EBI”. After LED element 301 “EB94” on the optical axis of micro lens 32 on the center of the figure radiates, a dot with formation image “IB94” is formed on the optical axis of micro lens 32 on the center of the figure. After LED element 301 “EB188” radiates, a dot with formation image “IB188” is formed 0.0424 mm above dot “ICI” that contains image formed by LED element 301 “EC1”. After LED element 301 “EC94” on the optical axis of micro lens 32 on the lower part of the figure radiates, a dot with formation image “IC94” is formed on the optical axis of the micro lens 32 on the lower part of the figure.

Next, in order to confirm the effect of embodiment 1 of the present invention, different printing images were evaluated by using printer 100 that installs LED head 3 (exposing device) in embodiment 1˜6 and comparison example 1˜6 in FIG. 11.

Moreover, in FIG. 11, aperture number N.A. (Numerical Aperture) can be shown as sin(θ) when θ° is served as the half angle of the maximum vertical angle of the circular cone of the incidence light from the lens. Because the maximum volume of the aperture number is 1, the larger the aperture number is, the more light the lens can take in. Therefore, it is possible to obtain bright image.

Further, MTF (Modulation Transfer Function) shows the resolution of the exposing device and the contrast of the light quantity of the image formed by the radiation LED element in the exposing device. The maximum contrast of the formation image is 100%. At this time, the resolution of the exposing device is high. The smaller MTF is, the smaller the contrast of the light quantity is and the lower the resolution of the exposing device becomes.

When the maximum volume of the light quantity of the formation image is served as “Imax” and the minimum volume of the light quantity of the two adjacent formation images is served as “Imin”, the MTF(%) can be shown by arithmetic formula 2 as follows.

<MTF>(Imax−Imin)/(Imax+Imin)×100% arithmetic formula 2

The evaluation of the image, as shown in FIG. 10, performs the printing process by using the evaluation image data formed by 1 tonder dot with interval of 0.0846 mm, that is, in the whole dot that can be formed in 600 dpi, performs the printing process by using the evaluation image data that formed by a dot. Then it evaluates the uniformity of the image concentration of the printing image in embodiment 1˜6 and comparison example 1˜6 one by one.

The result shows that when LED head 3 in embodiment 1˜6 is used, it is possible to get a good image with uniform concentration. On the other hand, when LED head 3 in comparison example 1˜6 is used, a white line by can be seen in one part of the evaluation image because the high concentration line in the cross direction of the arrangement direction of LED element 301 and the tonner image are not formed here.

Further, the formation image of the evaluation image stated above is shot by a microscope digital camera. The image is located at position “LI(mm)” from the side surface of the formation image surface side (photosensitive body drum 41 side) of lens array substrate 31 on lens array substrate 31. And MTF is calculated by analyzing the distribution of the light quantity of the image formed by LED element 301 through the shooting image.

The result shows that in the image evaluation stated above, when the images are good in embodiment 1˜6, MTF is over 85%. On the other hand, when a line can be seen in one part of the evaluation image in comparison example 1˜6, MTF is under 75%.

Here, FIG. 12 shows the relation between the absolute value of the magnification of micro lens 32 “mag” and the length of LED array 30 “SY” when the images are good in LED head 3 in embodiment 1˜6. The black circles in the figure that meet the requirement in embodiment 1˜6 are on curve “SY=12.0/mag”. Further, because the shorter the length “SY” is, the better the optical resolution is, it is possible to form printer 100 that can printing high-resolution image if LED head 3 satisfies arithmetic formula 2 as follows.

SY≦12.0/mag arithmetic formula 3

Therefore, as shown in FIG. 10, the formula becomes “SY>12.0/mag” in comparison example 1˜6.

Further, plural LED heads with different length of LED array 30 “SY” (not shown), but same aperture number “N.A” and the absolute value of the magnification “mag” are manufactured and their MTF is compared. As shown in the result, the shorter the length of LED array 30 “SY” is, the higher the MTF of the formation image of LED element 301 is. That is, when the aperture number “N.A.” and the absolute value of the magnification “mag” are the same, the shorter the length of LED array 30 “SY” is, the better the optical resolution is.

According to embodiment 1 of the present invention, as each micro lens 32 on lens array substrate 31 forms an enlargement image of each LED array 30 on LED array substrate 300, it is possible to get full-resolution image with simply structure and reduced numbers of parts.

Further, as the optical axis of each LED array 30 and each micro lens 32 are formed as a unified entity, it is not necessary to adjust the position of the lens, therefore, possible to provide easy position adjustment for the lens and have high productivity while reducing the size of the device.

Further, when the distance of the radiation point on the both ends of LED array 30 is served as “SY” and the absolute value of magnification of micro lens 32 is served as “mag”, it is possible to form a high-resolution exposing device that can improve the resolution of the formation image if formula “SY≦12.0/mag” holds.

At this time, it is more desirable if the distance of the radiation point “SY” becomes 2.0˜6.0 mm and the absolute value of magnification of micro lens 32 “mag” becomes 2.0˜4.0.

If “SY” is under 2.0 mm, in order to confirm a fixed exposure field, the number of parts is increased because of the increasing number of necessary LED array 30 and micro lens 32; and if “SY” is over 4.0 mm, the exposing device becomes large because of the longer distance from LED array 30 to the surface of the formation image.

Further, if “mag” is under 2, in order to get a fixed enlargement image, it is necessary to enlarge the size of LED element 301 and this will raise the manufacture cost; and if “mag” is over 4, during image forming process, the disorder of the position of LED element 301 arranged in a straight line is intensified and the quality of the print is deteriorated.

Further, diaphragm 34 that stops down the radiation light from each LED array 30 is set up between LED array substrate 300 and lens array substrate 31 so as to shade the useless light in the image forming process. It is also possible to prevent the influence of the light from adjacent LED array 30. Therefore, the resolution of the formation image is further improved.

Further, because plural micro lens 32 were formed as a unified entity, it is possible to improve the degree of precision of the position of individual micro lens 32 and the degree of precision of the center position of each lens surface. Therefore, it is possible to reduce the assembling error during the manufacture process as well as reduce the number of parts and improve the productivity.

Above is the explanation of a color electrophotographic printer serving as an image forming apparatus in embodiment 1. However, the present invention is not limited to the foregoing embodiments but many modifications and variations are possible within the spirit and scope of the appended claims of the invention. It can also be applied to electrophotographic facsimile, copying machine, or multi-functional machine with plural functions. It may also form monochrome image besides color image.

Further, LED array 30 is composed of a single tip, but it also may be composed of plural adjacent tips.

Further, lens array substrate 31 uses plural micro lens 32 which were formed as a unified entity, but it may also use individual micro lens 32.

Further, micro lens 32 is composed of a single piece of lens, but it also may be composed of plural lens in the direction of the optical axis.

Further, the surface of micro lens 32 is not limited to non-spherical surface shape, the surface shape of one direction can be different from the surface shape of other directions. It may be non-axis contrastive anamorphic non-spherical surface, troy dull surface and cylinder surface corresponding to the optical axis, as well as well-known free curved surface. Hence, the aberration of the lens is reduced and the resolution can be improved. Further, micro lens 32 may also be served as spherical surface and paraboloid. Hence, the optics characteristic declines when the comparative aberration is big. But it can be manufactured comparatively easily and its degree of precision is good, thus the productivity can be improved.

### Embodiment 2

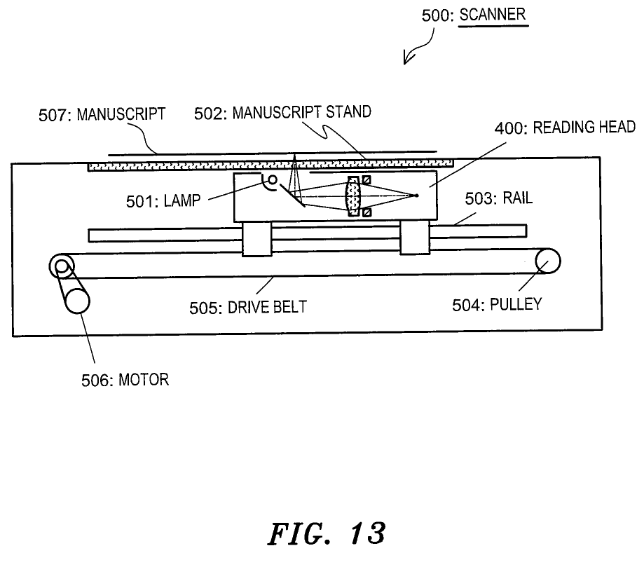

Next, it is to explain a reading apparatus in embodiment 2 in the present invention on the basis of FIG. 13˜FIG. 21.

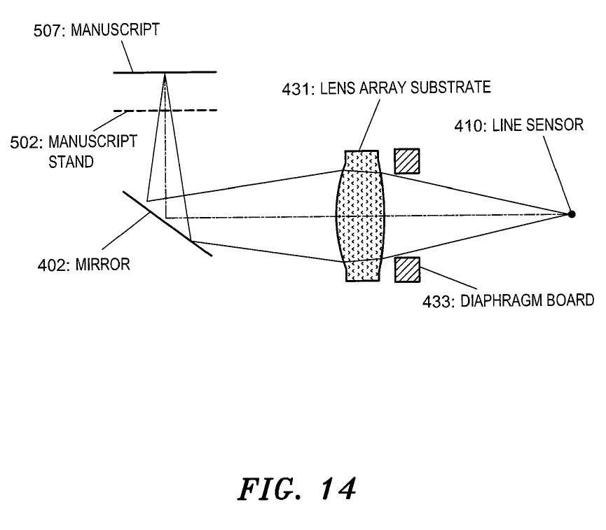

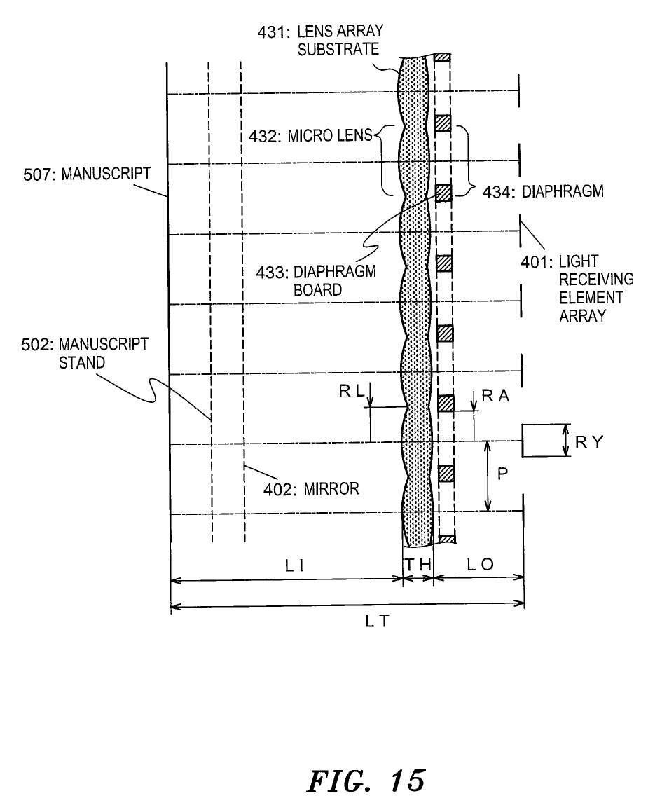

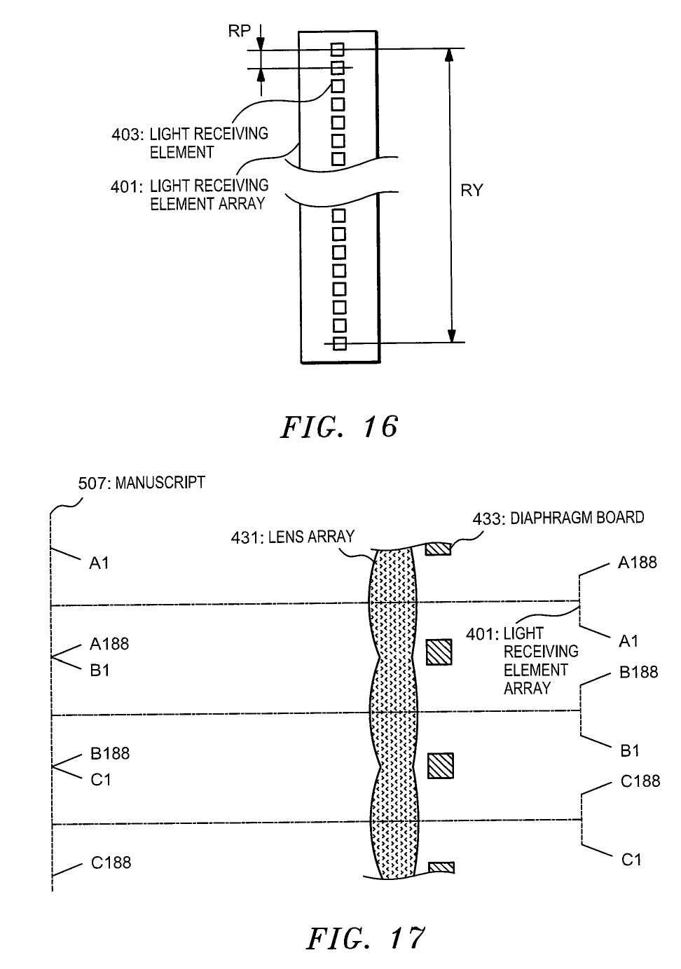

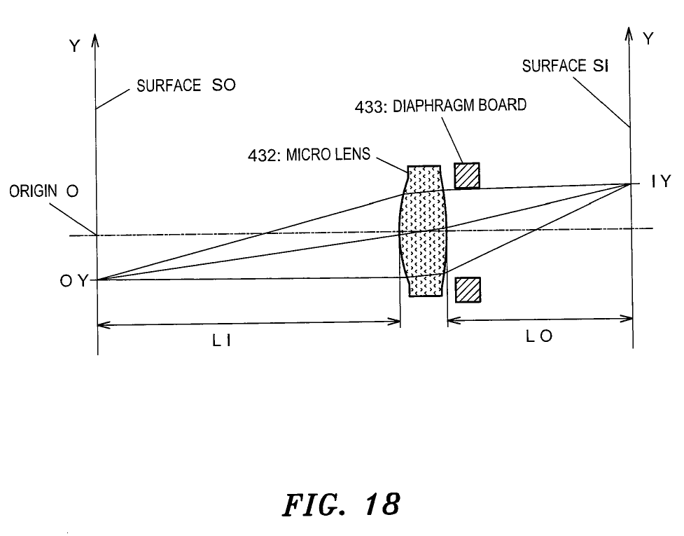

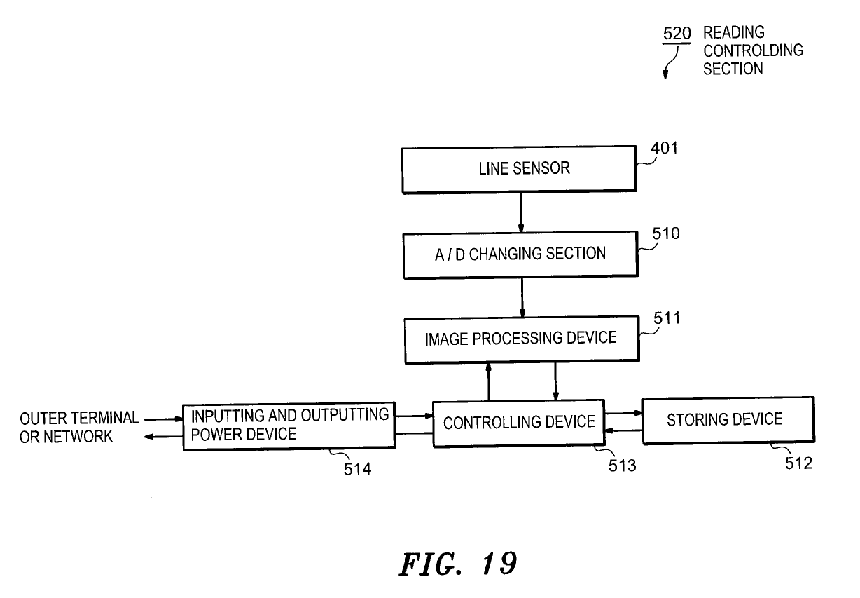

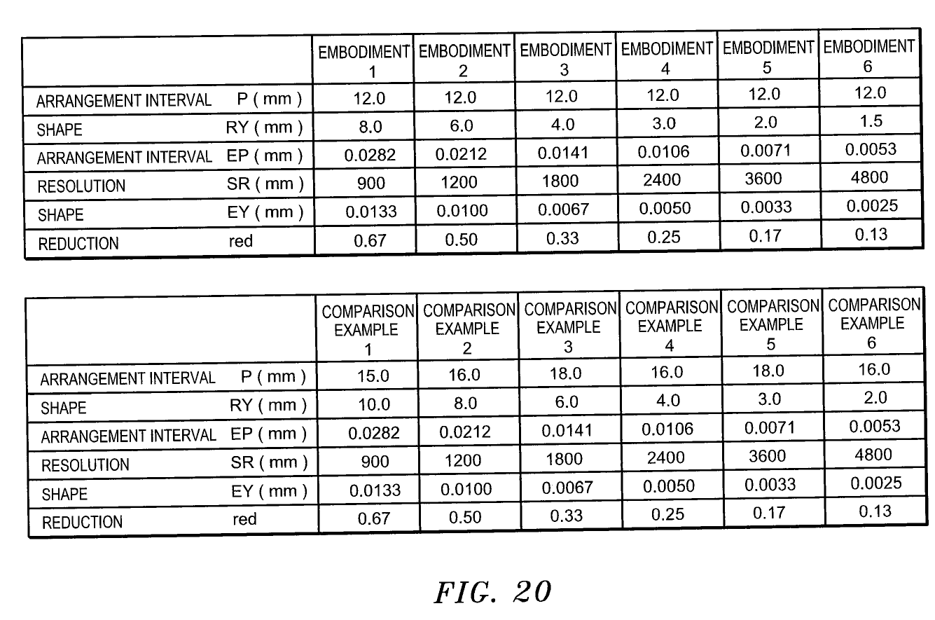

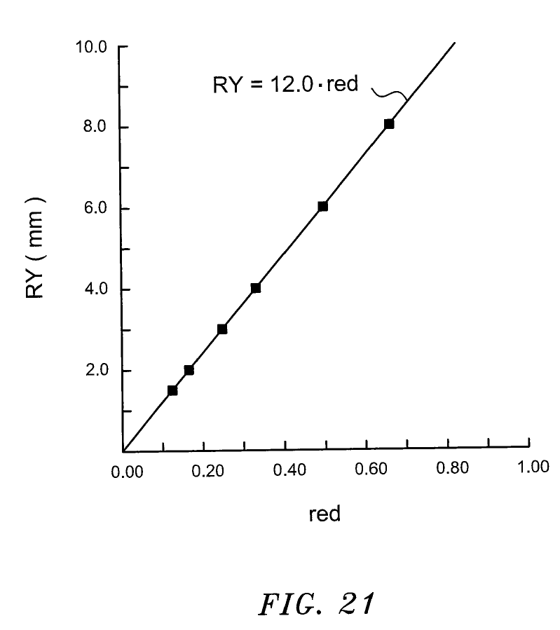

FIG. 13 is a diagram showing a main structure of a reading apparatus in embodiment 2; FIG. 14 is a diagram showing a structure of a reading head; FIG. 15 is a cross-sectional side view showing a reading head; FIG. 16 is a diagram showing a structure of a light receiving element array; FIG. 17 is a diagram showing a position on a light receiving element array formed by an incident light of manuscript image; FIG. 18 is a diagram showing the reduction rate of a micro lens; FIG. 19 is a block diagram showing a structure of a reading controlling section; FIG. 20 is a diagram showing a reading head in embodiment 2 and a reading head in comparison example; and FIG. 21 is a diagram showing a “red-RY” curve.

Scanner 500 serving as a reading apparatus in embodiment 2, as shown in FIG. 13, includes manuscript stand 502 on which manuscript 507 is set up, reading head 400 that reads out the manuscript, rail 503 that upholds reading head 400, drive belt 505 that moves reading head 400, pulley 504 that extends drive belt 505, motor 506 that rotates pulley 504 and drives drive belt 505. Drive belt 505 is connected with reading head 400.

Reading head 400 stated above changes the image of the light that reflects on the surface of manuscript 507 into a taking-in electricity signal. It includes lamp 501 that radiates the light onto manuscript 507 as shown in FIG. 14, mirror 402 that changes the route of the light reflected from manuscript 507, lens array substrate 431 that incidents the reflection light of mirror 402 and forms the formation image of the manuscript image, line sensor 410 serving as a shooting section that changes the formation image of the manuscript image into a electricity signal, diaphragm board 433 with plural forms diaphragm 434 that forms an aperture section shading the useless light in the image forming process of the manuscript image.

Lens array substrate 431 stated above is composed of one piece of lens arranging plural micro lens 432 in a straight line. Micro lens 432 on lens array substrate 431 and diaphragm 434 on diaphragm board 433 are set up opposite to each other and formed as a unified entity. Moreover, lens array substrate 431 is formed by the same material as lens array substrate 31 in embodiment 1 stated above.

Further, line sensor 410 is formed by arranging light receiving element array 401 (according to FIG. 16) with plural light receiving element 403 in a straight line in plural straight lines with predetermined interval.

Light receiving element array 401 stated above, as shown in FIG. 15, is set up in a line with predetermined interval “P” in the same direction as the arrangement direction of light receiving element 403. Micro lens 432 and the diaphragm 434 are set up in a straight line with fix interval as light receiving element array 401 and parallel the arrangement direction of the light receiving element 403. The center of the arrangement direction of the light receiving element on light receiving element array 401, diaphragm 434 and micro lens 432 are formed as unified entity under the conditions that the optical axis of them are in unison.

Here, the interval between manuscript 507 and micro lens 432 is served as “LI”; the interval between incidence surface and radiation surface of micro lens 432 is served as “TH”. The interval of micro lens 432 and light receiving element array 401 is served as “LO”; the interval of light receiving element array 401 and manuscript 507 is served as “LT”. The radius of micro lens 432 is served as “RL”; the absolute value of the reduction rate is served as “red”. The aperture radius of diaphragm 434 is served as “RA”.

Light receiving element array 401 stated above, as shown in FIG. 16, is formed by arranging plural light receiving element 403 in a straight line with predetermined interval “RP”. Light receiving element 403 forms a square. Further, in the field of light receiving element 403 arranged on light receiving element array 401, the length of the arrangement direction of light receiving element 403 is “RY”. That is, the distance between light receiving elements 403 on both ends of light receiving element 403 is “RY”.

Moreover, the resolution of light receiving element array 401 “SR” is shown by the number of light receiving element 403 arranged in every 1 inch. Its unit is “dpi”.

Here, it is to explain the reduction rate of micro lens 432 stated above on the basis of FIG. 18.

As shown in FIG. 18, in the direction of the optical axis of micro lens 432, a surface that was separated from “LO” by the radiation surface of micro lens 432 is served as surface “SI”; a surface that was separated from “LI” by the incidence surface of micro lens 432 in the direction of the optical axis of micro lens 432 is served as surface “SO”. Further, the crosspoint of surface “SO” and the optical axis of micro lens 432 is served as origin “O”; and the position of the light source is served as “OY”. When micro lens 432 forms an inverted image and the position of the formation image formed on surface “SI” by the light source is served as “IY”, the reduction rate of micro lens 432 becomes “−IY/OY”. Therefore, the absolute value of the reduction rate of micro lens 432 “red” becomes “IY/OY”.

Moreover, the structure and the interval of lens array substrate 431, diaphragm board 433 and diaphragm 434 in embodiment 2 are the same as the ones in LED head 3 in embodiment 1 stated above.

In embodiment 2, when the absolute value of the reduction rate of micro lens 432 is served as “red”; the arrangement interval of light receiving element 403 is served as “RP”; the length of the arrangement direction of light receiving element array 401 is served as “RY”; and the arrangement interval of light receiving element array 401 is served as “P”, a line sensor 410 that satisfies of the formula “P=(RY+RP)/red” is formed.

Next, it is to explain the relation of the position of light receiving element 403 arranged on light receiving element array 401 according to the manuscript image on the basis of FIG. 17.

FIG. 17 is an example showing the arrangement of 188 light receiving elements 403 on light receiving element array 401. At this time, the resolution of light receiving element 403 “RP” is 1200 dpi and the length of the arrangement direction of light receiving element 403 “RY” is 4.0 mm.

In FIG. 17, there are 188 dots of the manuscript image in each line. The three lines are set as “A”, “B” and “C”, and the dots are set as “A-1”, “A-2”, . . . “A-187”, “A-188”, “B-1”, “B-2”, . . . “B-187”, “B-188”, “C-1”, “C-2”, . . . “C-187”, “C-188” from the top to the bottom. At this time, as each micro lens 432 on lens array substrate 431 forms a inverted reduction image, light receiving element 403 corresponding to each dot of the manuscript image is set as “A-1”, “A-2”, . . . “A-187”, “A-188”, “B-1”, “B-2”, . . . “B-187”, “B-188”, “C-1”, “C-2”, . . . “C-187”, “C-188” from the top to the bottom.

Further, scanner 500 includes reading controlling section 520 that controls the sending of the image digital data on the basis of the requirement read from the outer device (outer terminal and network).

Reading controlling section 520, as shown in FIG. 19, includes inputting and outputting power device 514, controlling device 513, storing device 512, A/D changing section 510 and image processing device 511.

Next, it is to explain the action of scanner 500 in embodiment 2 on the basis of FIG. 13, FIG. 14 and FIG. 19.

As shown in FIG. 19, after inputting and outputting power device 514 received a requirement of the image digital data read from the outer device; as shown in FIG. 13, lamp 501 of scanner 500 is on; the surface of manuscript 507 installed on manuscript stand 502 is lightened; and the reflection light on the surface of manuscript 507 is taken into reading head 400. The rotation of motor 506 drives drive belt 505; reading head 400 and lamp 501 move in horizontal horizontality as a unified entity; and reading head 400 in the middle of them takes in the reflection light from the whole manuscript.

That is, in FIG. 14, the reflection light from manuscript 507, penetrates manuscript stand 502 and incidents in each micro lens 432 on lens array substrate 431 whose light route is changed by mirror 402. At this time, in the incidence light on lens array substrate 431, the useless light (stray light) is shaded by diaphragm board 433 in the image forming process of the manuscript image. The formation image of the manuscript image that was inverted and reduced in the absolute value of the reduction rate “red” by each micro lens 432 is formed on each light receiving element array 401 of line sensor 410. On light receiving element array 401, the luminance information of the formation image is changed into the analog signal.

The analog signal outputted from light receiving element array 401, as shown in FIG. 19, is inputted into A/D changing section 510 and changed into the digital data. Furthermore, after a fixed revision process is done in image processing device 511, the digital data of the manuscript image is temporarily stored into storing device 512 through controlling device 513. Then, the digital data of the manuscript image stored in storing device 512 is sent to the outer device through controlling device 513 and inputting and outputting power device 514 according to the requirement read from the outer device.

Next, in order to confirm the effect of embodiment 2 of the present invention, the manuscript image was evaluated by using scanner 500 that installs reading head 400 in embodiment 1˜6 and comparison example 1˜6 in FIG. 20.

The evaluation of the image, as shown in FIG. 10, performs the printing process by using the evaluation image data formed by 1 dot with interval of 0.0846 mm, that is, in the whole dot that can form in 600 dpi, performs the printing process by using the evaluation image data that formed a dot. Then it fomrs the digital data (image data) of the evaluation image in reading head 400 in embodiment 1˜6 and comparison example 1˜6 and evaluates the image reading condition (shade quality of the image data) on the basis of the image data.

The result shows that when reading head 400 in embodiment 1˜6 is used, it is possible to avoid bad reading problem and get a good image with uniform concentration. On the other hand, when reading head 400 in comparison example 1˜6 is used, bad reading problem occurs because a liner concentration difference happens in the cross direction of the arrangement direction of light receiving element 403.

Further, because lens array substrate 431 of reading head 400 in embodiment 1˜6 and comparison example 1˜6 has the same structure as lens array substrate 31 of LED head 3 in embodiment 1 stated above, MTF that shows the resolution of the formation image is shown in FIG. 11.

That is, when the images are good in embodiment 1˜6, MTF is over 85%. On the other hand, when bad reading problems occur in comparison example 1˜6, MTF is under 75%

Here, FIG. 21 shows the relation between the absolute value of the reduction rate of micro lens 432 “red” and the length of light receiving element array 401 “RY” when the image data is good in reading head 400 in the embodiment 1˜6 The black squares that meet the requirement in embodiment 1˜6 are on straight line “RY=12.0×red”.

Further, when the aperture number “N.A.” and the absolute value of the reduction rate of micro lens 432 “red” are the same, the shorter the length of the light receiving element array “RY” is, the better the resolution of micro lens 432 is. Therefore, it is possible to form scanner 500 that does not have bad reading problem if reading head 400 satisfies arithmetic formula 4 as follows.

RY≦12.0×red arithmetic formula 4

Therefore, as shown in FIG. 20, the formula becomes “RY>12.0×red” in comparison example 1˜6. Further, when the reduction rate is the same, the size of light receiving element 403 in embodiment 1˜6 is smaller than the one in comparison example 1˜6.

According to embodiment 1 of the present invention, as each 1 micro lens 432 on lens array substrate 431 forms a reduction image of the manuscript image on each light receiving element array 401 arranged on line sensor 410, it is possible to get full-resolution image with simply structure and reduced numbers of parts.

Further, as the optical axis of each light receiving element array 401 and each micro lens 432 are formed as a unified entity, it is not necessary to adjust the position of the lens, therefore, possible to provide easy position adjustment for the lens and have high productivity while reducing the size of the device.

Further, when the distance of the light receiving element on both ends of light receiving element array 401 is served as “RY” and the absolute value of the reduction rate of micro lens 432 is served as “red”, it is possible to form high-resolution reading apparatus 500 that can improve the resolution of the formation image if formula “SY≦12.0×red” holds.

Further, diaphragm board 43 that stops down the radiation light from each lens is set up between line sensor 410 and lens array substrate 431 so as to shade the useless light in the image forming process. It is also possible to prevent the influence of the radiation light from the adjacent lens. Therefore, the resolution of the formation image is further improved.

Further, because plural micro lens 432 were formed as a unified entity, it is possible to improve the degree of precision of the position of individual lens and the degree of precision of the center position of each lens surface. Therefore, it is possible to reduce the assembling error during the manufacture process as well as reduce the number of parts and improve the productivity.

Above is the explanation of a scanner serving as a reading apparatus that changes the manuscript image into the digital data in embodiment 2. However, the present invention is not limited to the foregoing embodiments but many modifications and variations are possible within the spirit and scope of the appended claims of the invention. It can also be applied to sensor and switch that changes optics signal into electrical signal, as well as inputting and outputting power device, biometric authentication device, communication device and scanning micrometer that use the sensor and switch stated above.

Further, the line sensor serving as shooting section 410 can also be applied to area sensor.

The present invention is not limited to the foregoing embodiments but many modifications and variations are possible within the spirit and scope of the appended claims of the invention.

What is claimed is:

1. An exposing device, comprising:
a radiation point array substrate that arranges plural radiation point arrays with plural radiation points in a straight line, in plural straight lines with predetermined interval; and
a lens array substrate that is set up to correspond to the respective radiation point arrays and has plural lenses forming enlargement image of the radiation point array,
wherein the radiation point array substrate substantially parallels the lens array substrate under the condition that optical axis of each radiation point array is adjusted to that of each lens, and
when a distance of the radiation points on both ends of the radiation point array is served as “SY” and an absolute value of magnification of the lens is served as “mag”, formula “SY≦12.0/mag” holds.

2. The exposing device according to claim 1,
wherein the “SY” is 2.0˜6.0 mm.

3. The exposing device according to claim 1,
wherein the “mag” is 2.0˜4.0.

4. The exposing device according to claim 1,
wherein a diaphragm board with a diaphragm that stops down the radiation light from each radiation point array is furnished between the radiation point array substrate and the lens array substrate, and
the radiation point array substrate, the diaphragm board and the lens array substrate are set up as a unified entity under the condition that the optical axes of the radiation point array, the diaphragm and the lens respectively coincide.

5. The exposing device according to claim 1,
wherein the plural lens are formed as a unified entity.

6. The exposing device according to claim 1,
wherein the lens is composed of one piece of lens in optical axis direction.

7. An image forming apparatus, comprising:
an exposing device,
wherein the exposing device includes:
a radiation point array substrate that arranges plural radiation point arrays with plural radiation points in a straight line, in plural straight lines with predetermined interval; and
a lens array substrate that is set up to correspond to the respective radiation point arrays and has plural lenses forming enlargement image of the radiation point array,
wherein the radiation point array substrate almost parallels the lens array substrate under the condition that optical axis of each radiation point array is adjusted to that of each lens, and
when a distance of the radiation points on both ends of the radiation point array is served as “SY” and an absolute value of magnification of the lens is served as “mag”, formula “SY≦12.0/mag” holds.

8. The image forming apparatus according to claim 7,
wherein the “SY” is 2.0˜6.0 mm.

9. The image forming apparatus according to claim 7,
wherein the “mag” is 2.0˜4.0.

10. The image forming apparatus according to claim 7,
wherein a diaphragm board with a diaphragm that stops down the radiation light from each radiation point array is furnished between the radiation point array substrate and the lens array substrate, and
the radiation point array substrate, the diaphragm board and the lens array substrate are set up as a unified entity under the condition that the optical axes of the radiation point array, the diaphragm and the lens respectively coincide.

11. The image forming apparatus according to claim 7,
wherein the plural lens are formed as a unified entity.

12. The image forming apparatus according to claim 7,
wherein the lens is composed of one piece of lens in optical axis direction.

13. An reading apparatus, comprising:
an image shooting section that arranges plural light receiving element arrays with plural light receiving elements in a straight line, in plural straight lines with predetermined interval; and
a lens array substrate that is set up to correspond to each light receiving element array and has plural lens to form reduction image of manuscript image on the light receiving element array,
wherein the image shooting section almost parallels the lens array substrate under the condition that optical axis of each light receiving element array is adjusted to that of each lens, and when the distance of the light receiving elements on both ends of the light receiving element array is served as “RY” and the absolute value of reduction rate of the lens is served as “red”, formula “RY≦12.0×red” holds.

14. The reading apparatus according to claim 13,
wherein a diaphragm board with a diaphragm that stops down radiation light from each lens is set up between the image shooting section and the lens array substrate, and the image shooting section, the diaphragm board and the lens array substrate are set up as a unified entity under the condition that optical axes of the light receiving element array, the diaphragm and the lens respectively coincide.

15. The reading apparatus according to claim 13,
wherein plural lens are formed as a unified entity.

16. The reading apparatus according claim 8,
wherein the lens is open-ended transitional term of one piece of lens in the optical axis direction.
